(19) United States
(12) Patent Application Publication
(10) Pub. No.: US 2023/0242704 A1
(43) Pub. Date: Aug. 3, 2023

(54) Low Creep Low Relaxation Fiber Reinforced Polymer Composites

(71) Applicant: United States of America as represented by the Administrator of NASA, Washington, DC (US)

(72) Inventors: Jeffrey A. Hinkley, Yorktown, VA (US); Jin Ho Kang, Newport News, VA (US); Keith L. Gordon, Hampton, VA (US); Sheila A. Thibeault, Hampton, VA (US)

(21) Appl. No.: 17/589,403

(22) Filed: Jan. 31, 2022

(51) Int. Cl. C08G 59/32; C08G 59/50

(52) U.S. Cl. CPC C08G 59/3227; C08G 59/504

(57) ABSTRACT

Various embodiments may include low-creep and low-stress-relaxation polymer composites (or reduced-creep and reduced-stress-relaxation polymer composites) and methods for making low-creep and low-stress-relaxation polymer composites (or reduced-creep and reduced-stress-relaxation polymer composites). Various embodiments may include a polymeric material, comprising: a tetrafunctional epoxy in an epoxy weight amount; an amine hardener in a hardener weight amount, wherein a weight ratio of the epoxy weight amount to the hardener weight amount is 1:0.38 or greater; and an oligomer additive in an additive concentration, the oligomer additive comprising a monomer combined with 4′-hydroxyacetanilide (HAA).

### STATEMENT REGARDING FEDERALLY SPONSORED RESEARCH OR DEVELOPMENT

The invention described herein was made in the performance of work under a NASA contract and by employees of the United States Government and is subject to the provisions of Public Law 96-517 (35 U.S.C. § 202) and may be manufactured and used by or for the Government for governmental purposes without the payment of any royalties thereon or therefore. In accordance with 35 U.S.C. § 202, the contractor elected not to retain title.

### BACKGROUND OF THE INVENTION

Deployable structures have been used to erect solar sails, solar arrays, antennas, payload booms, and planetary decelerators from the confined volume of launch vehicles. The large space structure is packaged prior to launch and deployed to the designed configuration at the mission location. Deployable space structures have been built from fiber reinforced polymer composite materials due to their low mass, high specific strength and high specific stiffness, but dimensional instability is a critical issue. The inherent viscoelastic behavior of polymers and the extended time of compacted stowage between assembly and deployment in space can result in performance degradation and, in the worst case, mission failure. Specifically, the extended time of stowage between assembly and in-space deployment can result in creep and stress relaxation of the composite that may manifest as dimensional instability during deployment, and in the worst case, mission failure.

When a tubular boom structure is stored by rolling it onto a spool, the boom becomes flattened, losing its initial shape. The area moment of inertia of a thin beam depends on the distance of material from the bending axis cubed. For example, a 25% reduction in total boom width will result in a loss of approximately 33% of the area moment of inertia, and this can result in loss margin in buckling strength.

The composites' relaxation originates from the viscoelastic behavior of polymeric materials. Under stress, parts of molecular chains or entire chains rearrange and slide past each other. Generally, thermosetting polymers can be expected to show less creep and stress relaxation compared to thermoplastic polymers due to restriction of chain motions by cross-linking. Particulate additives like silica may also reduce creep. However, state-of-the-art thermosetting polymers such as epoxy, cyanate ester, and bismaleimide resins still show large viscoelastic relaxation causing dimensional instabilities. The effect of silica particle on creep was demonstrated for only melt polymer resin at high temperature, and the polylactide is not applicable to aerospace structures.

### BRIEF SUMMARY OF THE INVENTION

Various embodiments may include low-creep and low-stress-relaxation polymer composites (or reduced-creep and reduced-stress-relaxation polymer composites) and methods for making low-creep and low-stress-relaxation polymer composites (or reduced-creep and reduced-stress-relaxation polymer composites). Low-creep and low-stress-relaxation polymer composites (or reduced-creep and reduced-stress-relaxation polymer composites) in accordance with various embodiments may be useful as elements of inflatable and deployable space structures, such as solar sails, solar arrays, antennas, payload booms, habitats, trusses, planetary decelerators, etc. Various embodiment method so making low-creep and low-stress-relaxation polymer composites (or reduced-creep and reduced-stress-relaxation polymer composites) may reduce relaxation and creep of the composite in comparison to traditional composites.

Various embodiments may include a polymeric material, comprising: a tetrafunctional epoxy in an epoxy weight amount; an amine hardener in a hardener weight amount, wherein a weight ratio of the epoxy weight amount to the hardener weight amount is 1:0.38 or greater; and an oligomer additive in an additive concentration, the oligomer additive comprising a monomer combined with 4′-hydroxyacetanilide (HAA).

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 illustrates cross section views of deployed prior art booms.

FIG. 2 illustrates example monomers for reactive low molecular weight oligomers suitable for use in various embodiments, specifically bisphenol A diglycidyl ether (DGEBA), vinylcyclohexene dioxide (VCD), and 4′-hydroxyacetanilide (HAA).

FIG. 3A shows stress relaxation data of a tetrafunctional epoxy sample at different temperatures.

FIG. 3B is a master curve of relaxation modulus created by the TTS method.

FIG. 4 illustrates fortifiers prepared from monomers in accordance with various embodiments.

FIG. 5 illustrates epoxy monomers in accordance with various embodiments.

FIG. 6A illustrates a cure cycling time example.

FIG. 6B illustrates a post-cure cycle.

FIG. 7A shows an example of individual stress relation data sets unshifted for Neat epoxy.

FIG. 7B shows an example of the individual relation curves of FIG. 7A horizontally shifted using time-temperature supposition.

FIG. 8 shows a TTS master curve comparison of Neat epoxies with TGDDM:DDS stoichiometric variance.

FIG. 9 is a graph of tan delta as a function of temperature.

FIG. 10 shows fortified epoxy TTS master curves compared with Neat epoxy.

### DETAILED DESCRIPTION OF THE INVENTION

For purposes of description herein, it is to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The word “exemplary” is used herein to mean “serving as an example, instance, or illustration.” Any implementation described herein as “exemplary” is not necessarily to be construed as preferred or advantageous over other implementations.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The following symbols as used herein have the following meanings:

Tg—glass transition temperature;

Eₐ—activation energy;

a_{T}—time-temperature shift factor; and

RM_{1 yr}—percent reduction in relations modulus at 1 year.

The following acronyms as used herein have the following meanings:

TRAC—Triangular Rollable And Collapsible;

CTM—Collapsible Tubular Mast;

TTS—Time Temperature Superposition;

DMA—Dynamic Mechanical Analyzer;

TGDDM—4,4′-Methylenebis(N,N-diglycidylaniline);

DDS—4-Aminophenyl sulfone;

DGEBA—Bisphenol A diglycidyl ether;

HAA—4-hydroxyacetanilide;

VCD—vinyla cyclohexane diepoxide;

SOA—state-of-the-art;

PMT—Patz Materials and Technology.

The payloads of current space launch systems, e.g. rockets, are constrained to a small size due to aerodynamic, weight, and cost limitations. Deployable structures allow for a folded or stowed configuration during launch and deployment at the mission location. Polymer composites have shown both high weight savings over current metallic structure, as well as improved specific mechanical strengths overall.

Deployable structures for space applications have the benefit of being compact during launch and expandable on orbit or at the mission location. Examples of deployable structures include expandable habitats, trusses, booms, solar sails and other large structures. The goal of these technologies is to build increasingly large space structures with the same or reduced launch costs, and the easiest way to accomplish this same or reduced launch cost is by the use of lighter materials. Carbon fiber reinforced polymer composite materials have played an increased role in aerospace vehicles and components due to their high specific strengths and stiffnesses.

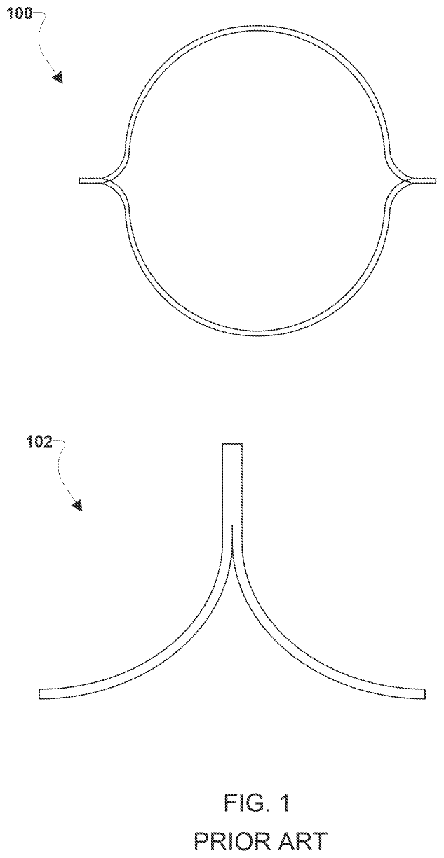

One category of deployable structures, composite booms, has been of increased focus due to the current interest in composite booms for solar sail and other NASA missions. These composite booms are composite versions of the Triangular Rollable And Collapsible (TRAC) boom and Collapsible Tubular Mast (CTM), shown in FIG. 1. FIG. 1 illustrates cross-sections of a CTM 100 in a deployed state and a TRAC boom 102 in a deployed state.

One issue encountered with polymer composite deployables, however, is stress relaxation of the polymer matrix in the stowed configuration. During stowage, each boom is flattened and rolled around a center spool. Satellites and other payloads may be stored for up to one year before launch or eventual deployment. Permanent deformation via stress relaxation may result as a consequence of this long-term storage. For example, after just one month of storage at room temperature a CTM boom deployed cross section width has been observed to reduce from 23 millimeters to 16 millimeters, a 28% reduction in CTM boom deployed width. The area moment of inertia of a hollow cylinder depends on its radius to the fourth power, so a 25% reduction in radius could result in a loss of 68% in buckling strength. This decrease in buckling strength could lead to failure of the boom assembly.

Various embodiments may include low-creep and low-stress-relaxation polymer composites (or reduced-creep and reduced-stress-relaxation polymer composites) and methods for making low-creep and low-stress-relaxation polymer composites (or reduced-creep and reduced-stress-relaxation polymer composites). Low-creep and low-stress-relaxation polymer composites (or reduced-creep and reduced-stress-relaxation polymer composites) in accordance with various embodiments may be useful as elements of inflatable and deployable space structures, such as solar sails, solar arrays, antennas, payload booms, habitats, trusses, planetary decelerators, etc. Various embodiment methods of making low-creep and low-stress-relaxation polymer composites (or reduced-creep and reduced-stress-relaxation polymer composites) may reduce relaxation and creep of the composite in comparison to traditional composites. Various embodiments may provide a new multifunctional epoxy resin with a fortifying additive that may show 70% less stress relaxation after one year as compared to a state-of-the-art (SOA) aerospace epoxy matrix. Various embodiments are discussed in relation to low or reduced creep and/or low or reduced relaxation which is a discussion used herein to compare the various embodiment polymer composites and various embodiment methods for making embodiment polymer composites in relation to SOA composites, such as PMT F7, used in boom applications. As used herein, low or reduced creep and/or low or reduced relaxation describe the various embodiment polymer composites used as material for a boom in comparison to SOA composites, such as PMT F7, used as material for a boom. A boom made from SOA composites, such as PMT F7, loses over half of its buckling strength after stowage and may experience over sixteen percent creep, whereas a boom made from various embodiments polymer composites may not lose over half its buckling strength after stowage and may experience less than sixteen percent creep, thereby making the various embodiments polymer composites low or reduced creep and/or low or reduced relaxation polymer composites.

Various embodiments may provide new, stiff molecular structures containing aromatic rings that can only rotate around the ring axes. With such structures, bond torsions do not lead to changes in the chain configuration. Experiments have confirmed that some imide-based resins showed about 40% less stress relaxation than an epoxy resin.

Various embodiments may include adding reactive second-phase components to restrict large scale rearrangements of polymer molecules. Experiments confirmed that a reactive fortifier, specifically bisphenol A diglycidyl ether (DGEBA) and 4-hydroxyacetanilide (HAA), showed a remarkable improvement in relaxation of a factor of three better than state-of-the-art baseline material.

Various embodiments may include securing strong interfaces between reinforcing fibers and the polymer matrix by chemical bonding to prevent slippage under load. In various embodiments, carbon fibers may be functionalized with reactive sizing materials to ensure strong covalent bonds between the carbon fiber and the polymer matrix using meta-chloroperoxybenzoic acid (for creating epoxide groups) and 4,4′-diamino-3,3′-dihydroxybenzidine (HAB) or 1,3′-diaminobenzoic acid (DAB).

Various embodiments have been shown by experiments to provide an improvement in creep/relaxation by a factor of five compared to state-of-the-art carbon-fiber-reinforced polymer composites. For example, a thin-ply, spread-tow carbon fiber plain weave fabric in accordance with various embodiments has been shown a creep of only approximately 5% relaxation in modulus during 2 years' storage at 40° C.

Various embodiments may include a polymeric material showing low (or reduced) viscoelastic creep and relaxation prepared by tailoring molecular structures and incorporating secondary additives.

Various embodiments may include fiber reinforced polymer composites showing low (or reduced) viscoelastic creep and relaxation prepared by tailoring molecular structures and incorporating secondary additives.

Various embodiments may include methods of suppressing viscoelastic creep and relaxation by controlling cross-linking density using reactive functional groups monomers.

Various embodiments may include methods of suppressing viscoelastic creep and relaxation by increasing molecular steric hindrance by reducing free volume and enhancing inter-molecular interaction.

Various embodiments may include methods of suppressing viscoelastic creep and relaxation by optimizing fiber layup configuration.

Various embodiment polymeric material showing low (or reduced) viscoelastic creep and relaxation prepared by tailoring molecular structures and incorporating secondary additives and/or various embodiment fiber reinforced polymer composites showing low (or reduced) viscoelastic creep and relaxation prepared by tailoring molecular structures and incorporating secondary additives may provide deployable space structures with excellent dimension stability, including payload booms, solar sail deployer booms, solar power arrays, antennas, space habitats, inflatable habitats for long-duration human exploration, drag sail deorbiting systems, and planetary decelerators. In addition, embodiment polymeric material showing low (or reduced) viscoelastic creep and relaxation prepared by tailoring molecular structures and incorporating secondary additives and/or various embodiment fiber reinforced polymer composites showing low (or reduced) viscoelastic creep and relaxation prepared by tailoring molecular structures and incorporating secondary additives may be useful in a range of terrestrial applications in aeronautics, automobiles, and civil engineering.

In an embodiment method, a material, such as an epoxy based material, may be prepared or synthesized as a base structure for a low creep low relaxation composite (or reduced creep reduced relaxation composite). For example, an epoxy based material may be selected because cross-linking can be controlled by selecting appropriate monomers and adjusting stoichiometry. As one example, a tetrafunctional epoxy may be prepared. As another example, a difunctional epoxy may be synthesized. As a specific example, tetrafunctional epoxy may be prepared from 4,4′-methylenebis(N,N-diglycidylaniline) (TGDDM, Sigma Aldrich, MO, USA) cured with 4,4′-diaminodiphenyl sulfone (DDS, Sigma Aldrich, MO, USA) at a weight ratio, such as a weight ratio of 1:0.38, 1:0.44, etc. Resin and hardener may be mixed at a temperature above room temperature, such as at 110° C., to get a homogenous mixture and degassed in a vacuum oven before curing. The combined resin and hardener may be referred to herein as an epoxy system. For example, TGDDM and DDS combined may be referred to as an epoxy resin system that is TGDDM/DDS or merely TGDDM/DDS. The mixed resin may be cured at a range of one or more temperatures for one or more time periods, such as cured at 120° C. for 1 hour, followed by 150° C. for 2 hours and 177° C. for 2 hours with ramp rates of 3° C./min. The cured mixed resin may be subjected to a post cure condition of a range of one or more temperatures for one or more time periods at one or more pressures, such as a post cure condition of 204° C. for 4 hours under ambient pressure. As other examples, the epoxy based material may include tetraglycidyl methylenedianiline (TGMDA), triglycidyl para-aminophenol (TGPAP), or multifunctional novolac epoxies, such as EPON™ Resin SU-2.5, EPIKOTE™ Resin 154, etc. As specific examples, the TGMDA, TGPAP, or multifunctional novolac epoxies may be combined with a hardener to form an epoxy system, such as a hardener including DDS to form an epoxy resin system that is TGMDA/DDS, TGPAP/DDS, etc. As further examples, in addition to, or in place of, DDS, the amine hardener may be another type aromatic diamine.

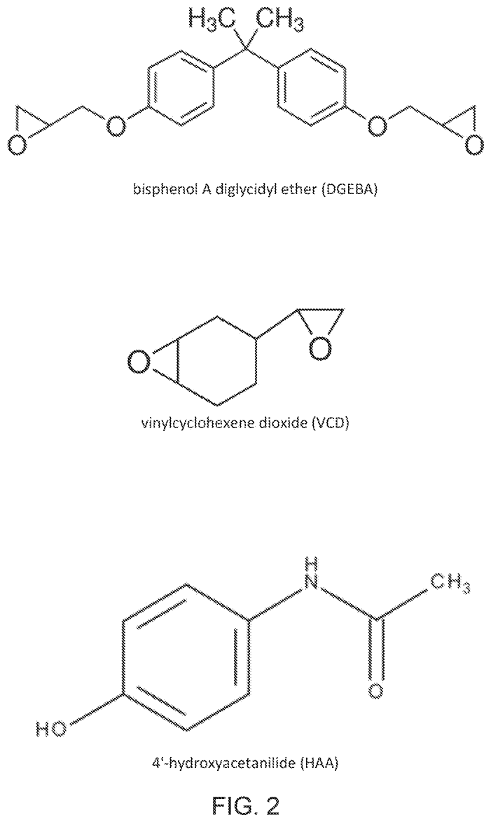

In an embodiment, a material, such as an epoxy based material, may be prepared or synthesized as a base structure for a low creep low relaxation composite (or reduced creep reduced relaxation composite) and reactive low molecular weight oligomers (also known as anti-plasticizers) may be added to the material. Example fortifiers and/or anti-plasticizers are discussed in U.S. Pat. No. 4,816,533 to Mclean et al. and U.S. Pat. No. 4,480,082 to Mclean et al., both of which are hereby incorporated in their entirety by reference for all purposes. Reactive low molecular weight oligomers are thought to cause molecular steric hindrance by reducing free volume and enhancing inter-molecular interaction. The reactive low molecular weight oligomers may have epoxide, primary or secondary amine, or hydroxy groups which may react with the material, such as the epoxy based material. In addition, polar ketone groups can induce strong inter molecular interaction via hydrogen bonding. Example monomers for the reactive low molecular weight oligomers suitable for use in various embodiments are illustrated in FIG. 2 and include bisphenol A diglycidyl ether (DGEBA), vinylcyclohexene dioxide (VCD), and 4′-hydroxyacetanilide (HAA). Other monomers may be used. A reactive low molecular weight oligomeric additives may be prepared, such as by mixing monomers. For example, DGEBA and HAA may be combined to synthesize bisphenol A diglycidyl ether/4′-hydroxyacetanilide (DGEBA/HAA) as an additive. The DGEBA/HAA additive may be synthesized by mixing DGEBA and HAA (1:1 mole ratio) at 140° C. for about 15 minutes. As another example, VCD and HAA may be combined to synthesize vinylcyclohexene dioxide/4′-hydroxyacetanilide (VCD/HAA) as an additive. The additive may be synthesized by mixing VCD and HAA (1:1 mole ratio) at 110° C. for about 15 minutes. The prepared reactive low molecular weight oligomer, such as DGEBA/HAA, VCD/HAA, etc., may be added into the epoxy resin system, such as TGDDM/DDS, TGMDA/DDS, or TGPAP/DDS as examples, at a loading level, such as a loading level of 17.5 to 35 parts per hundred (phr) relative to epoxy+amine (e.g., 17.5 phr relative to epoxy+amine, 35 phr relative to epoxy+amine, etc.). The mixed epoxy resin system and prepared reactive low molecular weight oligomer, such as DGEBA/HAA, VCD/HAA, etc., may be cured at a range of one or more temperatures for one or more time periods, such as cured at 120° C. for 1 hour, followed by 150° C. for 2 hours and 177° C. for 2 hours with ramp rates of 3° C./min. The cured mixed epoxy resin system and prepared reactive low molecular weight oligomer may be subjected to a post cure condition of a range of one or more temperatures for one or more time periods at one or more pressures, such as a post cure condition of 204° C. for 4 hours under ambient pressure.

In various embodiments, a carbon fiber fabric layup configuration may be selected to adjust the relaxation in modulus of carbon fiber reinforced composites. For example, 0-90 PW (plain weave) piles and/or unidirectional (UD) piles may reduce the relaxation in modulus.

Various embodiments may include a polymeric material including a tetrafunctional epoxy in an epoxy weight amount and an amine hardener in a hardener weight amount. In various embodiments, the polymeric material may further include an oligomer additive in an additive concentration. In various embodiments, the polymeric material may further include one or more carbon fiber fabric layups. In various embodiments, a weight ratio of the epoxy weight amount to the hardener weight amount may be such that there is more epoxy than amine hardener in the polymeric material. In various embodiments, the tetrafunctional epoxy may be 4,4′-methylenebis(N,N-diglycidylaniline) and the amine hardener may be 4,4′-diaminodiphenyl sulfone. In various embodiments, the tetrafunctional epoxy may be tetraglycidyl methylenedianiline (TGMDA), triglycidyl para-aminophenol (TGPAP), or multifunctional novolac epoxies, such as EPON™ Resin SU-2.5, EPIKOTE™ Resin 154, etc. In various embodiments, the amine hardener may be an aromatic diamine other than DDS. In various embodiments, a weight ratio of the epoxy weight amount to the hardener weight amount may be 1:0.38 or greater, such as a ratio of 1:0.38, a ratio from 1:0.38 to 1:0.44, a ratio of 1:0.44, a ratio from 1:0.38 to 1:0.50, a ratio of 1:0.44 to 1:0.50, a ratio of 1:0.50, a ratio of 1:0.38 to 1:0.55, a ratio of 1:0.55, a ratio of 1:0.44 to 1:0.55, a ratio of 1:0.50 to 1:0.55, etc. In various embodiments, a weight ratio of the epoxy weight amount to the hardener weight amount may be less than 1:0.38. In various embodiments, a weight ratio of the epoxy weight amount to the hardener weight amount may be greater than 1:0.55. In various embodiments, the oligomer additive may include a monomer combined with 4′-hydroxyacetanilide (HAA). In various embodiments, the monomer may be bisphenol A diglycidyl ether (DGEBA) and/or vinylcyclohexene dioxide (VCD). In various embodiments, other monomers may be used. In various embodiments, the additive concentration may be at least 17.5 grams per 100 grams of a combined weight of the tetrafunctional epoxy and the amine hardener, such as 17.5 grams per 100 grams of a combined weight of the tetrafunctional epoxy and the amine hardener, 17.5-35 grams per 100 grams of a combined weight of the tetrafunctional epoxy and the amine hardener, 35 grams per 100 grams of a combined weight of the tetrafunctional epoxy and the amine hardener, etc. In various embodiments, the additive concentration may be less than 17.5 grams per 100 grams of a combined weight of the tetrafunctional epoxy and the amine hardener. In various embodiments, at least one of the one or more carbon fiber fabric layups may include a 0-90 plain weave (PW) layup and/or a unidirectional layup. In various embodiments, the polymeric material of various embodiments may be used to form a part of a deployable component of a deployable structure. For example, the polymeric material of various embodiments may be used to form a part of a tubular boom flattened when in a stored configuration. For example, the polymeric material of various embodiments may be used to form a part of a deployable space structure, such as a payload boom, solar sail deployer boom, solar power array, antenna, space habitat, planetary decelerator, etc.

An approach to providing novel low creep and low stress relaxation polymer composites (or reduced creep and reduced stress relaxation polymer composites) for inflatable and deployable space structures in accordance with various embodiments includes: (1) controlling cross-linking density using reactive functional groups, keeping a good balance between restriction of molecular rearrangement and material brittleness; (2) increasing steric hindrance by reducing free volume and enhancing intermolecular interaction; and (3) optimizing fiber layup configuration.

As discussed herein, experiments using a formulated tetra-functional neat epoxy resin and modifications that epoxy resin were characterized using Dynamic Mechanical Analysis (DMA). The effects on stress relaxation from changes in stoichiometry and of antiplasticizing additives (“fortifiers”) were examined in the various experiments. The primary figure of merit from the experiments was the percent decrease of relaxation modulus at 1 year (RM1 yr), extrapolated from master curves generated using time-temperature superposition (TTS).

Examples in accordance with the various embodiments, specifically Example 1, Example 2, Example 3, and Example 4 are discussed below in the following paragraphs and tables, Table 1, Table 2, Table 3, and Table 4. Table 1 provides precent relaxation of modulus of different epoxy systems. Table 2 provides precent relaxation of modulus of different epoxy systems modified with reactive oligomers. Table 3 provides precent relaxation of modulus of different epoxy systems modified with reactive oligomers. Table 4 lists example epoxy resin formulations and properties.

### Example 1

First, epoxy based material was selected as a base structure for a novel low creep low relaxation composite (or reduced creep and reduced stress relaxation polymer composites), because it is relevant to aerospace applications and the cross-linking can be controlled by selecting appropriate monomers and adjusting stoichiometry. Tetrafunctional epoxy was prepared from 4,4′-methylenebis(N,N-diglycidylaniline) (TGDDM, Sigma Aldrich, MO, USA) cured with 4,4′-diaminodiphenyl sulfone (DDS, Sigma Aldrich, MO, USA) at a weight ratio of 1:0.38 (or 1:0.44). Resin and hardener were mixed at 110° C. to get a homogenous mixture and degassed in a vacuum oven before curing. The mixed resin was cured at 120° C. for 1 hour, followed by 150° C. for 2 hours and 177° C. for 2 hours with ramp rates of 3° C./min. Post cure condition was 204° C. for 4 hours, all under ambient pressure. Difunctional epoxy was synthesized using diglycidyl ether of bisphenol A diglycidyl ether (DGEBA, Sigma Aldrich) and 3,4′ oxydianiline (ODA, Sigma Aldrich) at 1:1 equivalents ratio of functional groups. Cure conditions were similar to those for the tetrafunctional epoxy. Commercial cured novolac epoxy (PMT-F7, Patz Materials and Technology, the baseline for comparison in the examples and experiments described herein (also sometimes referred to herein as SOA expoxy or baseline material)), was obtained from Patz Materials and Technology (CA, USA) and used as a control without further treatment.

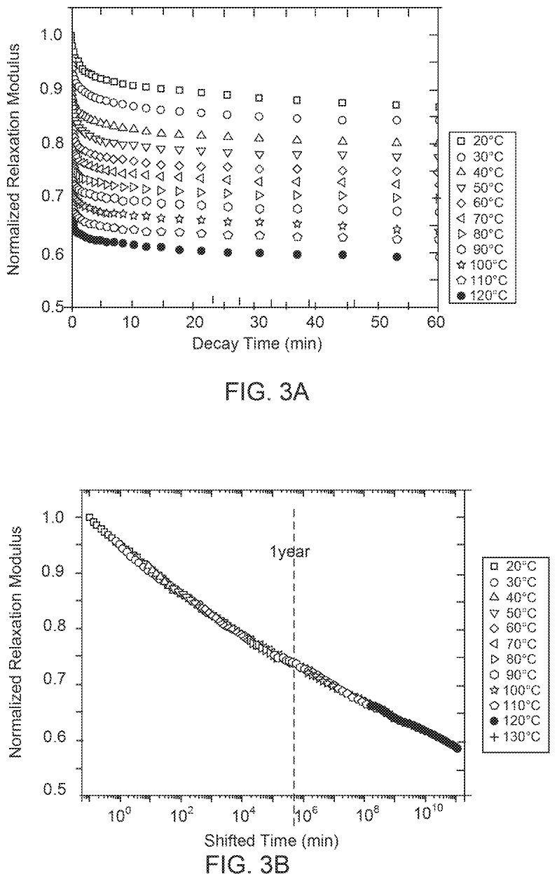

Viscoelastic properties of candidate materials were characterized from storage modulus and loss modulus at a heating rate of 1° C./min and a frequency of 1 Hz at low strain (0.1%) using a dynamic mechanical analyzer (DMA, Q800, TA Instruments). A dual cantilever fixture was used for polymers and 3-point bending for composites. Stress relaxation behavior was characterized from relaxation in modulus at 20° C. to 130° C. in increments of 10° C. At each temperature, a strain of 0.1% was applied. Relaxation was observed for 60 minutes and then the load was removed to allow 10 minutes for strain recovery and the ramp to the next temperature. From the raw data, a master curve was created using time-temperature-superposition (TTS). From this accelerated test, the extrapolated percent decrease of relaxation modulus at 1 year was calculated. An example of creating a master curve is shown in FIGS. 3A and 3B. FIG. 3A shows stress relaxation data of a tetrafunctional epoxy sample at different temperatures and FIG. 3B is a master curve of relaxation modulus created by the TTS method. Individual stress relaxation data for the tetrafunctional epoxy sample were obtained at certain temperatures (as shown in FIG. 3A) and the individual curves were shifted horizontally to form a continuous master curve as shown in FIG. 3B. The credibility of the master curve was confirmed by a linear relationship between the natural log of the shift factor and inverse temperature (i.e., Arrhenius law). In this case, the predicted relaxation modulus at 20° C. after 1 year (5.26×10⁵ min) was 26% lower than the initial modulus. Various candidate commercial polymers were selected based on the feasibility of fiber reinforced composite fabrication for applications involving confined storage prior to deployment. The predictions for relaxation due to confined stowage over a moderate time period are summarized in Table 1. The baseline commercial novolac epoxy material, PMT-F7, has a predicted 49% relaxation in modulus in 1 year at 20° C. A difunctional epoxy (DF epoxy) synthesized with 4,4′-isopropylidenediphenol diglycydyl ether showed higher relaxation of about 68% due to its lower crosslinking density. However, tetrafunctional epoxy synthesized with N,N′-tetraglycidyl diaminodiphenyl-methane (TGDDM) showed less relaxation (26˜34%) than the novolac epoxy, PMT-F7, due to its higher crosslinking density. The tetrafunctional epoxy prepared with a higher stoichiometric amine ratio (epoxy to amine=1:0.44 weight ratio) yielded less relaxation than the tetrafunctional epoxy prepared with a lower amine mixing ration (epoxy to amine=1:0.38 weight ratio).

### Example 2

The second method is to add reactive low molecular weight oligomers, which are known as anti-plasticizers. Reactive low molecular weight oligomers are thought to cause molecular steric hindrance by reducing free volume and enhancing inter-molecular interaction. The reactive low molecular weight oligomers should have epoxide, primary or secondary amine, or hydroxy groups which can react with epoxy resin system. In addition, polar ketone groups can induce strong inter molecular interaction via hydrogen bonding. Monomers used in Example 2 for the reactive low molecular weight oligomers are illustrated in FIG. 2. Two different reactive low molecular weight oligomeric additives were prepared: bisphenol A diglycidyl ether/4′-hydroxyacetanilide (DGEBA/HAA) and vinylcyclohexene dioxide/4′-hydroxyacetanilide (VCD/HAA) additives. The additive was synthesized by mixing DGEBA (or VCD) and HAA (1:1 mole ratio) at 140° C. (or 110° C. for VCD) for about 15 minutes. The prepared reactive low molecular weight oligomer was added into the epoxy resin system (TGDDM/DDS) at a loading level of 17.5 or 35 phr relative to epoxy+amine. Cure conditions for the modified epoxy resins were same as discussed above in Example 1. The percentages of relaxation in moduli of the modified epoxy specimens are summarized in Table 2. Compared to pristine epoxy (Tetrafunctional Epoxy-1, Table 1), the modified epoxy samples showed lower relaxation in modulus (about 15˜25%). The VCD/HAA oligomer (Tetrafunctional Epoxy-2-C and 2-D) produced a larger influence in reducing relaxation modulus than the DGEBA/HAA oligomer (Tetrafunctional Epoxy-2-A and 2-B). The smaller size of VCD monomer seems to be more effective to fill the free volume of epoxy resin to give stronger steric hindrance of molecules. Higher loading of reactive oligomer also showed slightly lower relaxation in modulus.

### Example 3

In this example, the effect of carbon fiber fabric layup configuration on the relaxation in modulus was investigated. Four different layup configurations of thin-ply, spread-tow carbon fiber plain weave fabric were used: [0-90 PW (plain weave)]₄, representative a highly stiff boom (Tetrafunctional Epoxy-3-A), [±45 PW]₄ to represent a highly flexible boom (Tetrafunctional Epoxy-3-B), [±45 PW₂/0-90 PW₂] to represent a small size boom application (Tetrafunctional Epoxy-3-C), and [±45 PW₂/0 UD (unidirectional)]ₛ for a large size boom application (Tetrafunctional Epoxy-3-D). The relaxation moduli of carbon fiber reinforced composites were characterized by the same technique used in example 1 & 2, and the results are shown in Table 3. Tetrafunctional Epoxy-3-B [±45 PW]₄ showed about 24% modulus relaxation in 1 year at 20° C. and about 29% relaxation in 2 years at 40° C. However, Tetrafunctional Epoxy-3-A [0-90 PW]₄ showed only about 4˜5% relaxation because the resin viscoelasticity contributes relatively little to that fiber-dominated layup. Adding 0-90 PW or UD layup into 45 PW layup reduced the relaxation in modulus (Tetrafunctional Epoxy-3-C and 3-D).

TABLE 1

| | | % Relaxation at |
|---|---|---|
| Sample | Specification | 1 year, 20° C. |
| Novolac Epoxy | Baseline, Commercial, PMT-F7 | 49 |
| Difunctional | Diglycidyl ether of bisphenol A | 68 |
| Epoxy | diglycidyl ether (DGEBA):3,4′ | |
| | oxydianiline (ODA) = 1:0.29 ratio | |
| Tetrafunctional | 4,4′-Methylenebis(N,N- | 34 |
| Epoxy-1 | diglycidylanil-ine) | |
| | (TGDDM):Diaminodiphenyl | |
| | sulfone (DDS) = 1:0.38 ratio | |
| Tetrafunctional | 4,4′-Methylenebis(N,N- | 26 |
| Epoxy-2 | diglycidylanil-ine) | |
| | (TGDDM):Diaminodiphenyl | |
| | sulfone (DDS) = 1:0.44 ratio | |

TABLE 2

| | | Initial Modulus | % Relaxation at |
|---|---|---|---|
| Sample | Specification | (GPa) | 1 year, 20° C. |
| Tetrafunctional | 4,4′-Methylenebis(N,N- | 3.68 | 25 |
| Epoxy-2-A | diglycidylanil-ine) | | |
| | (TGDDM):Diaminodiphenyl | | |
| | sulfone (DDS) = 1:0.38 ratio | | |
| | DGEBA/HAA additives, 17.5 phr | | |
| Tetrafunctional | 4,4′-Methylenebis(N,N- | 3.39 | 22 |
| Epoxy-2-B | diglycidylanil-ine) | | |
| | (TGDDM):Diaminodiphenyl | | |
| | sulfone (DDS) = 1:0.38 ratio | | |
| | DGEBA/HAA additives, 35 phr | | |
| Tetrafunctional | 4,4′-Methylenebis(N,N- | 3.87 | 17 |
| Epoxy-2-C | diglycidylanil-ine) | | |
| | (TGDDM):Diaminodiphenyl | | |
| | sulfone (DDS) = 1:0.38 ratio | | |
| | VCD/HAA additives, 17.5 phr | | |
| Tetrafunctional | 4,4′-Methylenebis(N,N- | 4.08 | 15 |
| Epoxy-2-D | diglycidylanil-ine) | | |
| | (TGDDM):Diaminodiphenyl | | |
| | sulfone (DDS) = 1:0.38 ratio | | |
| | VCD/HAA additives, 35 phr | | |

TABLE 3

| | | | % Relaxation at | % Relaxation at |
|---|---|---|---|---|
| Sample | Specification | Fiber Layup | 1 year, 20° C. | 2 year, 40° C. |
| Tetrafunctional | TGDDM:DDS = | [0-90 PW]₄ | 4 | 5 |
| Epoxy-3-A | 1:0.38 ratio | | | |
| | DGEBA/HAA | | | |
| | additives, 24 phr | | | |
| Tetrafunctional | TGDDM:DDS = | [±45 PW]₄ | 24 | 29 |
| Epoxy-3-B | 1:0.38 ratio | | | |
| | DGEBA/HAA | | | |
| | additives, 24 phr | | | |
| Tetrafunctional | TGDDM:DDS = | [±45 PW₂/0 | 22 | 30 |
| Epoxy-3-C | 1:0.38 ratio | UD]_{S} | | |
| | DGEBA/HAA | | | |
| | additives, 24 phr | | | |
| Tetrafunctional | TGDDM:DDS = | [±45 PW₂/0- | 16 | 21 |
| Epoxy-3-D | 1:0.38 ratio | 90 PW₂] | | |
| | DGEBA/HAA | | | |
| | additives, 24 phr | | | |

### Example 4

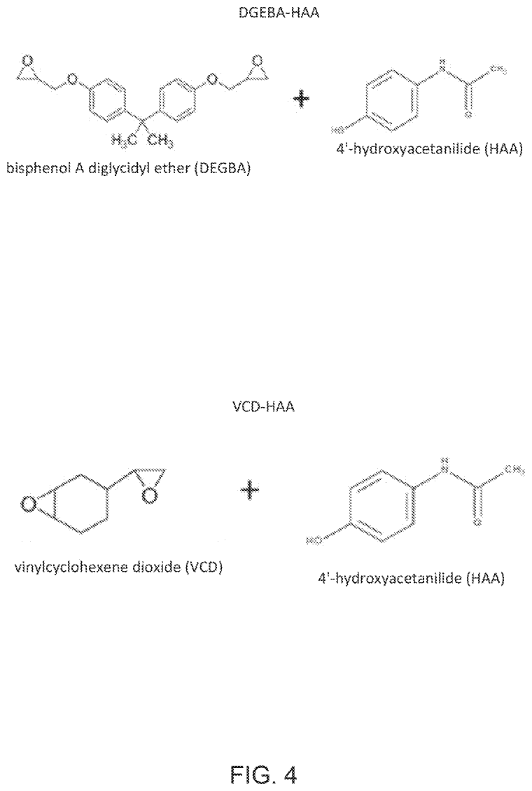

The baseline material, F7, was obtained from Patz industries. baseline material, F7, is primarily a trifunctional epoxy toughened with core-shell rubber particles. Although sometimes described a formulation that also contained 10% nano-silica, thermogravimetric analysis of the batch used in the experiments of Example 4 showed essentially no inorganic residue. Fortifiers were prepared from monomers purchased from Sigma-Aldrich. These monomers are shown in FIG. 4. The DGEBA-HAA fortifier (DGEBA) was produced by stirring HAA into liquid DGEBA (1:1 mole ratio) at 140° C. for approximately 15 minutes. A partially reacted fortifier was desired. The VCD-HAA fortifier was prepared similarly using VCD and HAA in a 1:1 molar ratio. The VCD was heated to 110° C. and the HAA powder was stirred in until a transparent solution was obtained, approximately 15 minutes.

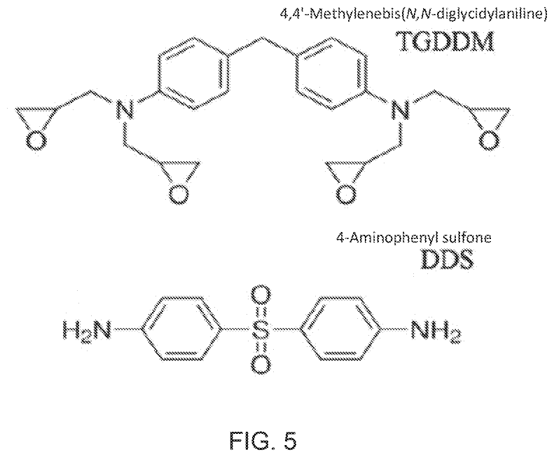

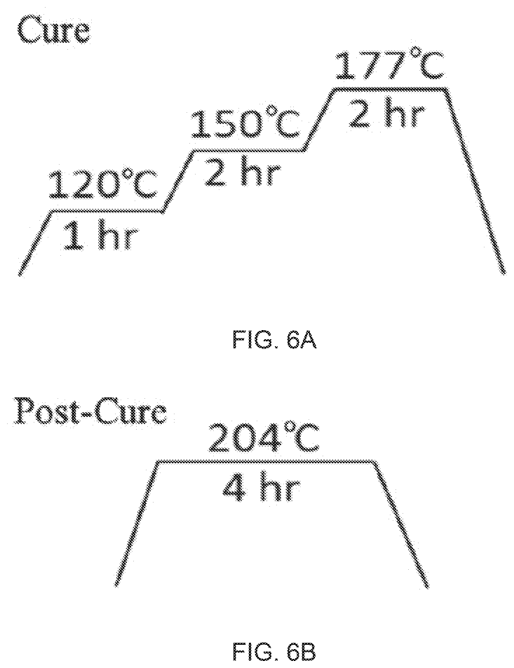

4,4′-Methylenebis(N,N-diglycidylaniline (TGDDM) and DDS—4-Aminophenyl sulfone (DDS) as illustrated in FIG. 5 were purchased from Sigma Aldrich and used as received. The TGDDM was cured with DDS using a method supplied by the manufacturer, but with slight variations in stoichiometry. If fortifier was to be added, it was stirred into the warm mixture after the DDS was added. Fortifier concentrations are denoted in phr, that is, weight in grams per hundred grams of epoxy+amine. A total of eight different epoxy resin formulations were prepared. The SOA epoxy tested (i.e., PMT F7) and the eight different formulations are listed with their relevant properties in Table 4. “Neat” denotes the resin batch identifier (ID) for TGDDM cured with DDS in which the weight ratio of the epoxy weight amount of TGDDM to the hardener weight amount of DDS was 1:0.44 and no oligomer additive was added. “Neat 1:038” denotes the resin batch ID for TGDDM cured with DDS in which the weight ratio of the epoxy weight amount of TGDDM to the hardener weight amount of DDS was 1:0.38 and no oligomer additive was added. “Neat 1:050” denotes the resin batch ID for TGDDM cured with DDS in which the weight ratio of the epoxy weight amount of TGDDM to the hardener weight amount of DDS was 1:0.50 and no oligomer additive was added. “Neat 1:055” denotes the resin batch ID for TGDDM cured with DDS in which the weight ratio of the epoxy weight amount of TGDDM to the hardener weight amount of DDS was 1:0.55 and no oligomer additive was added. “17.5 DGEBA” denotes the resin batch ID for TGDDM cured with DDS in which the weight ratio of the epoxy weight amount of TGDDM to the hardener weight amount of DDS was 1:0.44 and an oligomer additive of DGEBA-HAA was added at an additive concentration of 17.5 grams per 100 grams of the combined weight of the TGDDM cured with DDS. “35 DGEBA” denotes the resin batch ID for TGDDM cured with DDS in which the weight ratio of the epoxy weight amount of TGDDM to the hardener weight amount of DDS was 1:0.44 and an oligomer additive of DGEBA-HAA was added at an additive concentration of 35 grams per 100 grams of the combined weight of the TGDDM cured with DDS. “17.5 VCD” denotes the resin batch ID for TGDDM cured with DDS in which the weight ratio of the epoxy weight amount of TGDDM to the hardener weight amount of DDS was 1:0.44 and an oligomer additive of VCD-HAA was added at an additive concentration of 17.5 grams per 100 grams of the combined weight of the TGDDM cured with DDS. “35 VCD” denotes the resin batch ID for TGDDM cured with DDS in which the weight ratio of the epoxy weight amount of TGDDM to the hardener weight amount of DDS was 1:0.44 and an oligomer additive of VCD-HAA was added at an additive concentration of 35 grams per 100 grams of the combined weight of the TGDDM cured with DDS. The epoxy was heated to 110° C. in a sand bath and the DDS powder was stirred in. Once it was clear and homogenous, the solution was vacuum degassed at 115° C. and 30 inHg for approximately 15 minutes. After degassing, the resin was cast into dry preheated silicone molds. The cure and post-cure cycles are shown in FIGS. 6A for cure and 6B for post-cure.

TABLE 4

| | | | | | Activation |
|---|---|---|---|---|---|
| | | | | Initial | Energy, Eₐ |
| Resin | Epoxy:Amine | | | Modulus | α-relax |
| Batch ID | WT Ratio | Additive | RM_{1yr} ± 2 | (GPA) | (kJ/mol) |
| SOA Epoxy | N/A | Toughened with | 49% | 2.99 | 601 |
| (PMT F7) | | nano-silica and | | | |
| | | other company | | | |
| | | proprietary | | | |
| | | additives | | | |
| Neat 1:0.38 | 1:0.38 | — | 35% | 3.19 | N/A |
| Neat 1:0.50 | 1:0.50 | — | 31% | 3.60 | N/A |
| Neat 1:0.55 | 1:0.55 | — | 28% | 3.56 | N/A |
| Neat | 1:0.44 | — | 27% | 3.45 | — |
| 17.5 DGEBA | 1:0.44 | 17.5 phr | 25% | 3.68 | N/A |
| | | DGEBA-HAA | | | |
| 35 DGEBA | 1:0.44 | 35 phr | 22% | 3.39 | N/A |
| | | DGEBA-HAA | | | |
| 17.5 VCD | 1:0.44 | 17.5 phr | 17% | 3.87 | 656 |
| | | VCD-HAA | | | |
| 35 VCD | 1:0.44 | 35 phr | 15% | 4.08 | 530 |
| | | VCD-HAA | | | |

Once demolded, the castings were ground flat and sectioned into rectangular strips, 60 mm long, for DMA testing. Surface effects from oxidation are assumed to be negligible due to the exterior surfaces being ground off. All specimens were vacuum dried at 110° C. overnight after sectioning and then stored in a desiccator cabinet until testing to avoid water absorption.

Stress relaxation was tested in a TA Instruments® Q800 DMA equipped with a dual cantilever clamp. In a stress relaxation test, the DMA applies a constant strain to the material and records the decaying force at temperature. The initial and reference temperature for the stress relaxation data is 20° C. Testing was performed from 20° C. to 160° C. The full testing method was: step 1) equilibrate at 20° C.; step 2) isothermal for 20 min; step 3) data storage on; step 4) displace (0.1000%) for 60 minutes and recover for 10 minutes; step 5) data storage off; step 6) increment up 10° C.; and step 7) repeat steps 3-6 until temperature equals 1602° C. Each test resulted in 14 isothermal, accelerated stress relaxation data sets where each data set was collected at an increasing temperature as the experiment progressed.

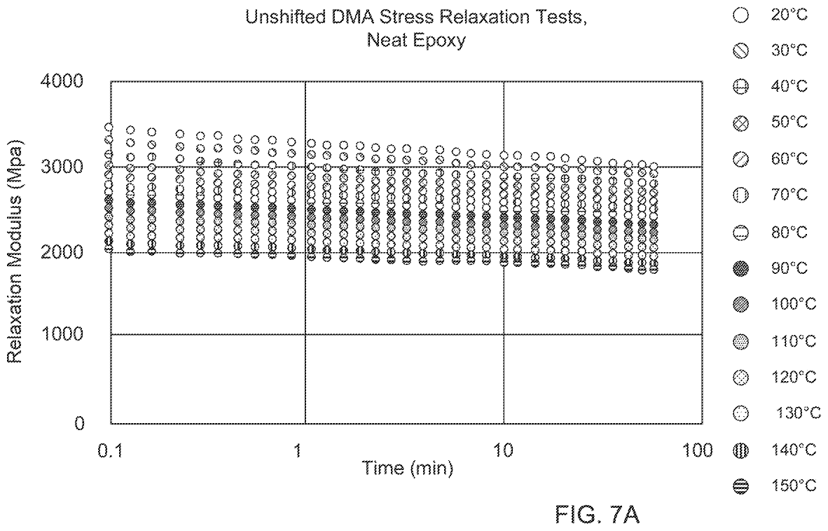

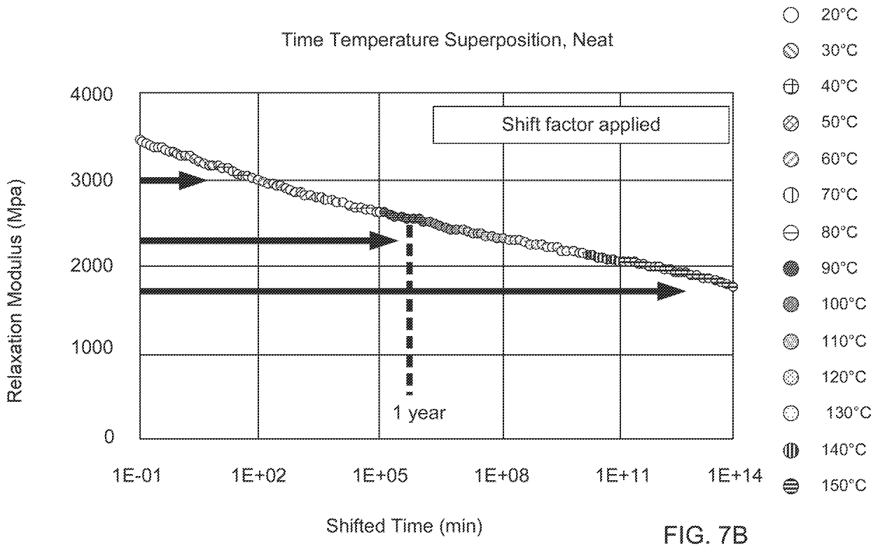

The results were plotted in log-linear space and manually shifted to generate a master TTS curve. FIG. 7A shows an example of individual stress relation data sets unshifted for Neat epoxy. FIG. 7B shows an example of the individual relation curves of FIG. 7A horizontally shifted using time-temperature supposition. The resulting master curve of FIG. 7B enables RM_{1 yr} predication. At each temperature, the applied time-temperature shift factor shifts that specific data set to the right, overlapping the data to produce a continuous curve, i.e., a master curve. Past experiments have shown agreement between master curves and actual long-term creep tests. RM_{1 yr}, the percent relaxation in one year, was calculated for each master curve from the ratio of the initial modulus to the modulus at one year.

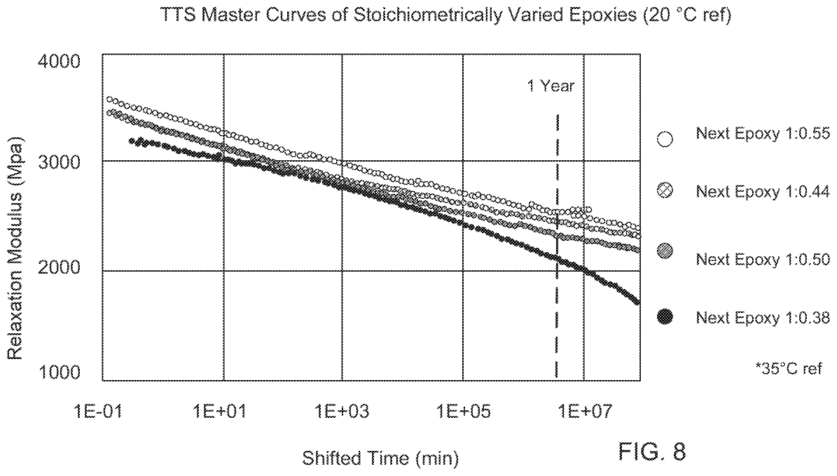

FIG. 8 shows a TTS master curve comparison of neat epoxies with TGDDM:DDS stoichiometric variance. FIG. 8 shows the effect of stoichiometric variations of the neat epoxy on the master curves. Small increases in the initial relaxation modulus were observed with an increasing amount of amine hardener. An increase in DDS from 1:0.38 ratio to 1:0.44 ratio (by weight) reduced the predicted RM_{1 yr} from 34% to 27%. It should be noted that the neat epoxy 1:0.38 resin was prepared and tested at different conditions and used a reference temperature of 35° C. Higher stoichiometric ratios of DDS:TGDDM did not yield any further improvement in relaxation properties. This is in agreement with other studies which find that an epoxy excess can suppress β-relaxations.

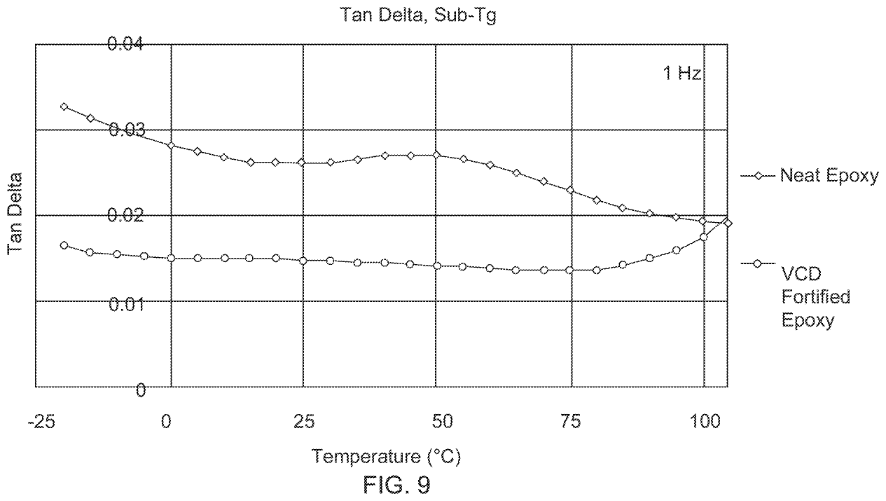

The addition of small molecules, called anti-plasticizers or fortifiers, into the matrix can increase the room temperature modulus while maintaining ductility. It is thought that they occupy free volume within the network and exert a local steric hindrance to chain mobility below Tg. One manifestation of this is suppression of the sub-Tg beta relaxation observed in DMA, as shown in FIG. 9. In FIG. 9, tan delta as a function of temperature at 0.1 Hz for neat tetra-functional epoxy and VCD fortified epoxy is graphed. The “bump” noted at around 50° C. is the β-relaxation associated with local molecular motions. This data was not collected for DGEBA fortified epoxy.

The addition of small fortifier molecules was shown to increase the initial elastic modulus and decrease sub-Tg relaxation in epoxies. Additionally, fortifiers are typically reactive with the main epoxy-amine network and can sterically hinder chain motion and increase the activation energy for β-relaxations. On this basis, it is reasonable to expect that fortifiers might decrease stress relaxation.

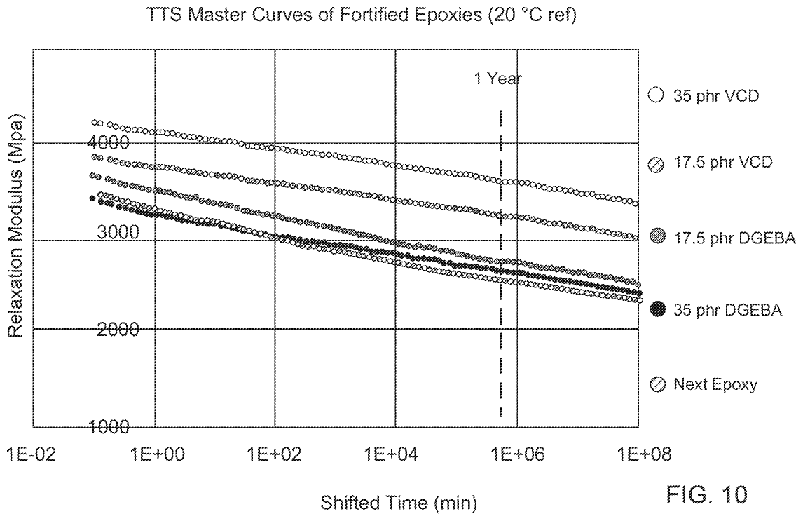

TTS curves for all fortified epoxies are shown below in FIG. 10. FIG. 10 shows all fortified epoxy TTS master curves compared with neat epoxy. VCD had the most pronounced effect on both the slope and the initial relaxation modulus. Of the two fortifiers tested, VCD gave the larger relative increase in relaxation modulus and had a larger impact on the relaxation properties. The DGEBA fortifier also decreased relaxation, but to a lesser extent. The resin fortified with VCD at 35 phr concentration exhibited the lowest RM_{1 yr} at 15% in 1 year at 20° C. This value is 70% lower than that of state-of-the-art epoxy resin (Patz Materials & Technology, PMT-F7) that had been chosen for NASA's Advanced Composite Solar Sail System (ACS3) project. While raising the concentration of VCD from 17.5 to 35 phr increased the initial relaxation modulus, it did not have a large impact on the RM_{1 yr} value. A summary of the results for all the formulations is shown in Table 4.

Starting from a tetra-functional epoxy resin, initial improvements in stress relaxation properties were observed when the amine hardener:epoxy ratio was increased; however further increases in hardener content did not yield significant changes to relaxation properties. The addition of small fortifying molecules was also observed to reduce relaxation and increase the initial elastic modulus of resins. An epoxy containing 35 phr of added VCD fortifier resulted in a RM1 yr value that is 70% lower than the state-of-the-art PMT-F7 resin, the state-of-the art PMT-F7 resin being a resin used in current booms. VCD appears to be a more effective fortifier than DGEBA in this tetra-functional epoxy.

Potential markets for low creep and low relaxation polymer composites (or reduced creep and reduced stress relaxation polymer composites) include deployable structures with excellent dimensional stability for morphing vehicles, inflatable/deployable camping habitats, structural ropes and etc. The extremely low viscoelastic property of the various embodiment novel fiber reinforced polymer composites may enable the construction of durable and mechanically stable sporting goods, such as skis and poles, snow boards, golf clubs, racquets, hockey sticks, bows, strings, etc. Other applications of the various embodiments may include textile industry applications (e.g., wrinkle free fabric) and military applications (e.g., composite structures, inflatable/deployable shelters, etc.).

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” As used herein, the term “and/or” includes any and all combinations of one or more of the associated listed items. As also used herein, the term “combinations thereof” includes combinations having at least one of the associated listed items, wherein the combination can further include additional, like non-listed items. Further, the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

Reference throughout the specification to “another embodiment”, “an embodiment”, “exemplary embodiments”, and so forth, means that a particular element (e.g., feature, structure, and/or characteristic) described in connection with the embodiment is included in at least one embodiment described herein, and can or cannot be present in other embodiments. In addition, it is to be understood that the described elements can be combined in any suitable manner in the various embodiments and are not limited to the specific combination in which they are discussed.

What is claimed is:

1. A polymeric material, comprising:
a tetrafunctional epoxy in an epoxy weight amount;
an amine hardener in a hardener weight amount, wherein a weight ratio of the epoxy weight amount to the hardener weight amount is 1:0.38 or greater; and
an oligomer additive in an additive concentration, the oligomer additive comprising a monomer combined with 4′-hydroxyacetanilide (HAA).

2. The polymeric material of claim 1, wherein the monomer is bisphenol A diglycidyl ether (DGEBA) or vinylcyclohexene dioxide (VCD).

3. The polymeric material of claim 2, wherein the additive concentration is at least 17.5 grams per 100 grams of a combined weight of the tetrafunctional epoxy and the amine hardener.

4. The polymeric material of claim 3, wherein the additive concentration is 17.5 grams per 100 grams of the combined weight of the tetrafunctional epoxy and the amine hardener.

5. The polymeric material of claim 3, wherein the additive concentration is 35 grams per 100 grams of the combined weight of the tetrafunctional epoxy and the amine hardener.

6. The polymeric material of claim 5, wherein the monomer is VCD.

7. The polymeric material of claim 6, wherein the tetrafunctional epoxy is 4,4′-methylenebis(N,N-diglycidylaniline) and the amine hardener is 4,4′-diaminodiphenyl sulfone.

8. The polymeric material of claim 7, wherein the weight ratio of the epoxy weight amount to the hardener weight amount is 1:0.44.

9. The polymeric material of claim 7, wherein the weight ratio of the epoxy weight amount to the hardener weight amount is 1:0.38.

10. The polymeric material of claim 2, wherein the tetrafunctional epoxy is 4,4′-methylenebis(N,N-diglycidylaniline) and the amine hardener is 4,4′-diaminodiphenyl sulfone.

11. A deployable structure, comprising:
a deployable component formed at least in part from a polymeric material comprising:
a tetrafunctional epoxy in an epoxy weight amount;
an amine hardener in a hardener weight amount, wherein a weight ratio of the epoxy weight amount to the hardener weight amount is 1:0.38 or greater; and
an oligomer additive in an additive concentration, the oligomer additive comprising a monomer combined with 4′-hydroxyacetanilide (HAA).

12. The deployable structure of claim 11, wherein the deployable component is a tubular boom flattened when in a stored configuration.

13. The deployable structure of claim 12, wherein the monomer is bisphenol A diglycidyl ether (DGEBA).

14. The deployable structure of claim 13, wherein the additive concentration is at least 17.5 grams per 100 grams of a combined weight of the tetrafunctional epoxy and the amine hardener.

15. The deployable structure of claim 14, wherein the tetrafunctional epoxy is 4,4′-methylenebis(N,N-diglycidylaniline) and the amine hardener is 4,4′-diaminodiphenyl sulfone.

16. The deployable structure of claim 12, wherein the monomer is vinylcyclohexene dioxide (VCD).

17. The deployable structure of claim 16, wherein the additive concentration is at least 17.5 grams per 100 grams of a combined weight of the tetrafunctional epoxy and the amine hardener.

18. The deployable structure of claim 17, wherein the tetrafunctional epoxy is 4,4′-methylenebis(N,N-diglycidylaniline) and the amine hardener is 4,4′-diaminodiphenyl sulfone.
